(19) United States
(12) Patent Application Publication
(10) Pub. No.: US 2007/0225173 A1
(43) Pub. Date: Sep. 27, 2007

(54) Ionically balanced polyacrylamide compositions for use in connection with agricultural chemicals

(76) Inventors: Mickey R. Brigance, Germantown, TN (US); Greg McManic, Memphis, TN (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 11/749,467

(22) Filed: May 16, 2007

Related U.S. Application Data
(63) Continuation-in-part of application No. 11/537,789, filed on Oct. 2, 2006.
Application No. 11/537,789 is a continuation of application No. 10/621,130, filed on Jul. 16, 2003, now abandoned.
(60) Provisional application No. 60/396,150, filed on Jul. 16, 2002.

(51) Int. Cl. A01N 25/10

(52) U.S. Cl. 504/361

(57) ABSTRACT

An ionically balanced composition for applying to soil or plants containing an aqueous solution of at least one anionic acrylamide polymer and an ionically balancing agent.

### REFERENCE TO A RELATED APPLICATION

This is a continuation-in-part of our copending patent application Ser. No. 11/537,789 filed Oct. 2, 2006, which in turn is a continuation of our copending patent application Ser. No. 10/621,130 filed Jul. 16, 2003, both of which are relied on and incorporated herein by reference. The benefit of provisional patent application No. 60/396,150, filed Jul. 16, 2002, is claimed and incorporated herein by reference.

### INTRODUCTION AND BACKGROUND

The present invention relates to an ionically balanced acrylamide polymer composition which exhibits enhanced performance properties such as compatibility with ionic and particularly highly cationic pesticide systems, improved electrolyte tolerance, and broadened systemic potentiation of pesticides while maintaining typical deposition and anti-drift characteristics. The composition may be in the form of a water solution, dispersion or reverse phase emulsion. The present invention is intended to avoid the incompatibility problems often encountered with pesticides which leads to gel formation or sedimentation of solid particulates.

Thus, as used herein, the terms “ionically balanced acrylamide polymer compositions” mean those compositions which when mixed with highly cationic pesticide formulations will form gel-free and particulate free, sprayable liquids.

It is well known in agriculture to apply various agrochemicals to growing areas by spraying. The growing areas may be crop areas, which can be very large, or smaller growing areas such as those in greenhouses. The agrochemicals applied as sprays include fertilizers, herbicides and pesticides.

It is well recognized by the agricultural industry that it is advantageous to the end-users to be able to formulate dry agricultural chemicals such as fertilizers, pesticides, and/or adjuvants so that they can be easily mixed with water and applied by means of a spraying apparatus to a target area.

Fertilizers can be supplied in various forms, in particular as solid compositions, powders, or as suspensions or solutions of the fertilizer in a liquid. Fertilizer solutions are generally supplied by the manufacturer as an aqueous concentrate in large batches of size around 1 ton in weight. The solutions contain high concentrations, often 10 to 80 wt. % (dry solids), of dissolved inorganic fertilizer.

Dry and liquid adjuvants and fertilizers are available to both the agricultural and nonagricultural markets, and each type of product has its advantages and disadvantages. For example, dry adjuvants and fertilizers have the advantages of containing a high concentration of active ingredients, and the ability to incorporate various ingredients into the composition to increase the efficacy of the composition. However, many dry adjuvants and fertilizers have a disadvantage in that they must be dissolved before use, which can be hazardous and require substantial mixing and long dissolving times. Incompatibility problems are common and create problems for the applicators.

Herbicides and pesticides can be supplied to the farmer in various forms, for instance as neat liquids, aqueous solutions, aqueous dispersions or slurries of solid herbicide or pesticide. It is normal practice for the manufacturer to supply the farmer with the herbicide or pesticide in the form of a neat liquid or as a high activity solution or slurry. The usual way of applying herbicides or pesticides to an area of land would be by spraying. It is important that the compositions to be sprayed are free of gel and particulates.

Various systems have been devised for convenient dosing of fertilizers, herbicides or pesticides. Spray pumps are well known which spray water from a spray manifold onto the area of land or crop area and which are designed so that concentrated fertilizer solution, herbicide or pesticide can be dosed into the pump, mixed with water before being sprayed.

The use of dry fertilizers and adjuvants are problematic because their solubility in water varies with various water qualities throughout the United States. Water temperatures, pH, hardness, and mineral content all affect the ease of dispersing or dissolving the fertilizer and adjuvants into the spray mixture. This unpredictable solubility has been a problem for end users applying herbicides to kill weeds. The end users typically prepare herbicidal mixtures using cold water, or water at ambient temperature, under varying conditions, and frequently outdoors where solubility problems cannot be satisfactorily resolved. The end users then face the problem of applying a suspension of fertilizer and adjuvant in water with the herbicide. The suspension can plug conveying lines, or cause an uneven application of the fertilizer and herbicide on vegetation, which results in an uneven kill rate and directly exposes an end user preparing the solution to undesirable herbicide and fertilizer contact. Gels and particulates cause even greater problems.

Mist, or the fine particles end of the droplet-size spectra in these agricultural sprays, i.e., those less than about 150 microns in diameter, often reduce the effectiveness of the chemical delivery process.

When the agricultural sprays are to be directed onto a specific target, the aerial spray or discharge delivery systems are typically mounted on airplanes, tractors, or ground equipment. However, as a result of spray drift, much of the active chemical ingredients in a spray, and especially in mist, can be rendered ineffective or lost because of the inability of the small diameter spray or mist particles to reach an impact upon the intended target, i.e., the crop or field locus. While small droplets provide better coverage of a target, they are more susceptible to drift than larger droplets. Spray drift represents a loss of agricultural chemical from intended targets and thus results in dangers inherent in air, ground, and water pollution. Since off-target agricultural chemicals are wasted product and can have a negative environmental and economic impact, especially if the agricultural spray medium contains fertilizer and most especially if the medium contains pesticide, it is in the interest of all for sprayers to reduce this drift induced problem.

For some applications it is common practice to combine two or more agrochemicals. For instance in the application of herbicides, especially systemic herbicides, it is convenient to combine the treatment with a fertilizer, such as for instance ammonium sulphate. The fertilizer stimulates the growth of unwanted plants causing them to take up more water, together with the herbicide, through the root system. This ensures a more efficient uptake and distribution of herbicide throughout the plant. In this instance the fertilizer may be regarded as an adjuvant in that it increases the efficacy of the herbicide. Thus, a fertilizer used in combination with a herbicide is termed a herbicide adjuvant.

During the spraying of fertilizers, herbicides and pesticides it is usual to apply anti-drift agents in order to prevent the formation of fine droplets which could be carried beyond the area intended to be treated. Without the use of anti-drift agents, the spraying of fertilizers, herbicides and pesticides would be inefficient, for the reason that, first of all because there could be inadequate treatment of the land and crop areas intended to be treated and secondly the extraneous spray, if carried beyond the intended treatment zone, could for example be detrimental to other crops, land and water courses.

It is usual to combine the anti-drift agent with either the water which is fed into the spray pumps or to apply it directly into the spray pumps, usually at or shortly after the mixing zone where the water is mixed with the herbicide, pesticide or aqueous fertilizer concentrate. It is important that the spray drift chemical is metered at the correct dose to ensure that extraneous spray is not formed through underdosing or through overdosing if the spray angle is too narrow resulting in uneven distribution of the pesticide, herbicide or fertilizer. It is very important when all the components and ingredients are blended that the resulting composition is free of gels and free of particulates.

In addition, significant differences in particle sizes between the individual components in a dry product can result in particle separation during shipping and/or storage. This leads to a non-homogeneous composition which, if applied without remixing, can lead to poor results or cause damage to treated vegetation. Furthermore, inherent tackiness or particle fines generated through attrition can result in compaction and/or caking before the end user applies the dry adjuvant and fertilizer.

Liquid adjuvants and fertilizers overcome the disadvantages of long dissolving times and particle separation. But, due to solubility limitations, liquid adjuvants and fertilizers are limited in the number and amount of components present in the liquid composition. In addition, incompatibilities between different composition components makes several liquid fertilizer compositions impossible to manufacture or store for extended time periods.

The inability to solubilize high percentages of active components in a liquid adjuvant or fertilizer is a major disadvantage. In particular, concentrated liquid adjuvants and fertilizers are required to avoid the high cost of shipping large amounts of water. Concentrated liquid adjuvants and fertilizers also have the problem of phase stability because solid components tend to precipitate or settle from the composition, or liquid components tend to form separate liquid phases.

In many farming areas, soil is deficient in one or more of the natural nutrients required for satisfactory growth of certain crops. As a result, such crops do not give their optimum yield.

When such conditions exist, it is a common procedure to apply a fertilizer rich in the required nutrients(s). The most common fertilizers in use today are the water-soluble, nitrogen-containing fertilizers. Solutions of the fertilizers are usually applied to the crop locus via aqueous spraying techniques; and, as described above, this spraying process usually results in the attendant product of fine mist and droplet drift.

One solution proposed in the art to reduce mist and chemical drift in aqueous agricultural sprays, such as those containing fertilizers, is to incorporate into the aqueous medium a viscosity-increasing amount of a guar gum or derivative of guar gum, specifically non-derivatized guar gum, non-cationic derivatized guar gum, cationic guar gum, or mixtures thereof.

For both dry and liquid adjuvants and fertilizers, it is desirable to incorporate several different ingredients, in a high concentration (if needed), into a single composition. For example, it is desirable to incorporate a fertilizer component, an adjuvant, a spreader-sticker (i.e., a deposition aid), a drift control agent, an antifoaming agent, and a pesticide (if desirable) into a single product. A single, multipurpose composition eliminates a need for the end user to inventory a large number of different chemicals. In addition, application of the chemicals is made easier and less hazardous, with a reduced chance of misapplication, because only one product is measured, dissolved, and applied. Combination adjuvants and fertilizers also are more environmentally friendly because fewer empty containers are generated, and fewer chemical containers are stored for long periods.

When an adjuvant is used in conjunction with an herbicide, a barrier to maximizing herbicide performance, especially at the lowest possible labeled use rates, is the application technique itself. In an effort to ensure the herbicide is applied within intended boundaries (i.e., does not drift), conventional sprayers utilize nozzle tips that produce large spray droplets. Research has shown that these large droplets are not retained by many species of vegetation, and, consequently, herbicide efficacy is reduced.

Attempts have been made to include various polymers with the fertilizer in a liquid formulation to improve the solubility and dispersibility of the fertilizer in water of a wide quality range. Unfortunately, some commonly used polymers and other organic substances, such as xanthan gum, have not been completely successful in solubilizing or dispersing efficacious concentrations of fertilizers in an aqueous solution.

Polymers of acrylamide and other ethylenically unsaturated monomers have been used as anti-drift agents. It has been generally accepted that polymers which give optimum spray drift control are either non-ionic (e.g. acrylamide homopolymer) or have relatively low anionic content (e.g. 5 to 30 wt. %) and also have relatively high intrinsic viscosity, for instance above 6 dl/g. Such polymers tend to form viscous aqueous solutions unless used at low concentration. Normal practice is to mix the polymer powder or reverse phase emulsion form with water directly into the spray tank so as to form an aqueous solution of polymer. However, this has the problem that emulsion polymers can be difficult to activate in this situation and polymer powders take a long time to dissolve. It is sometimes necessary to use more polymer as a result of inefficient dissolution of the polymer. Normally in order to minimize the problems with dissolution it would be usual to use polymers of intrinsic viscosity in the range 6 to 15 dl/g. Typically the water containing the pesticide, herbicide or fertilizer would comprise polymer at a concentration in excess of 0.05 wt. %.

When the concentrate is a solution in water or organic solvent, it is very rare to include polymeric material. However when the concentrate is a dispersion in water it is common to include a small amount of polymeric thickener and when the concentrate is a dispersible grain it is common to include a small amount of polymeric binder. A wide variety of polymers have been mentioned in the literature as thickeners and binders (for instance the cellulosic, acrylamide, vinyl alcohol and other polymers proposed in U.S. Pat. No. 4,657,781) but in practice very few polymers have been used. For instance the thickener is almost always xanthan gum. The thickeners and binders used in agricultural concentrates generally have high molecular weight, in order that they can impart the desired thickening or binding effect. They are generally present in a minor amount relative to the active ingredient, for instance less than 0.1 parts polymer per part by weight active ingredient.

Research efforts to reduce spray drift have typically dealt with improved equipment design, e.g., nozzle design to optimize spray patterns, or application techniques such as spray pressures, heights, formulations, etc. The most promising improvements in the application technology area have been in the reduction of fine spray droplets in the droplet spectrum during atomization via the use of spray modifiers known as drift control agents. Effective drift control agents must possess a great number of characteristics for they must be able to increase the small droplet size; be insensitive to the high shear process conditions realized in the spray system pumps, nozzles, etc.; not detract from the biological effects of the spray bioactives; be compatible with other spray adjuvants, i.e., non-bioactive material added to the spray mixture to improve chemical or physical characteristics; not separate upon standing; be easy to use; be environmentally friendly; and be cost efficient.

Drift control agents are usually high molecular weight polymers which, when added to aqueous systems, tend to increase the viscosity of the system and thus prevent the water from being broken up into a fine mist when aerially sprayed or discharged.

These high molecular weight polymers tend to be unstable in that they often degrade upon aging and are very shear sensitive; both of which conditions, upon occurrence, cause a decrease in solution viscosity with a concomitant decrease in drift control activity.

In U.S. Pat. No. 4,126,443 a very small amount of low molecular weight hydrolyzed acrylamide is incorporated into an aqueous concentrate of a particular herbicide in order to prevent crystallization within the concentrate. The polymer is formed of 50 to 99% acrylic acid groups and 1 to 50% acrylamide groups and is present in the concentrate in an amount that is recommended to be below 640 ppm (0.064%) although in one example the amount is 0.5%. The amount of active ingredient in the concentrate is from 20 to 40% and so when this is diluted to form a sprayable composition the concentration of polymer in the sprayable composition will be only a few parts per million.

It is also known to include polymers in the agricultural composition that is to be applied, so as to modify the properties of that composition. For instance, in EP-A-55857, a particular carbamate insecticide is blended with an excess of various film-forming polymers and applied as a film from an ethanol solution, and it is suggested that the effect of the polymer is to alter the crystallization properties of the carbamate when the solvent evaporates and a film is formed. There is no suggestion that the solution should be sprayed and the carbamate is not a foliar systemic active ingredient. Indeed the teaching in this patent (to adjust the crystallization properties) is clearly unrelated to systemic activity which requires absorption of the active ingredient, presumably while still in the liquid phase, through the leaves into the plant. The preferred polymers in EP 55857 are said to be water soluble cellulose derivatives but polymer acrylamides, ethylene oxide resins and water insoluble polyamides, esters and other polymers are mentioned including very high molecular weight polyethylene oxide. Since the compositions are cast as a film, it is clear that the polymer will have a major effect on the properties of the film and on the properties of the solution before drying.

U.S. Pat. No. 6,364,926 discloses a concentrated liquid adjuvant and fertilizer composition containing a nitrogen source, an ampholytic surfactant, a drift control agent/deposition aid, and a carrier in a single phase stable package.

U.S. Pat. No. 6,288,010 discloses a composition comprising a water solution of an inorganic water soluble compound such as ammonium sulfate of at least 10% by weight and an anti-drift agent which is a water soluble anionic polymer of intrinsic viscosity at least 6 dl/g. These polymers carry a minimum of 20% anionic character and up to 95% anionic character. These anionic polymers, due to the relatively high anionic character, exhibit high electrolyte tolerance being soluble in glyphosate concentrates and in ammonium sulfate solutions. However, the high anionic character of the polymers is not generally compatible with highly cationic pesticide formulations such as the newer commercially available glyphosate products (e.g., Round Up Weather Max and Original Max) causing gellation in the spray tank, which can clog nozzles and screens preventing proper application of the spray onto the target.

U.S. Pat. No. 5,964,917 relates to dry processing nitrogen fertilizers with guar gum, starch encapsulated silicone defoamer, and dedusting agent such a nonyl phenol ethoxylate.

U.S. Pat. No. 5,550,224 relates to use of guar, including both non derivatized and cationic guar, as a drift control agent at use levels in the spray mix of 10 to 37 oz. per 100 gallons (0.075 to 0.276% weight per unit volume). These polymers are non-viscoelastic which is different from polymer acrylamides, high mole weight polyethylene oxides, and polyvinylpyrrolidones in that guar in not sensitive to shear stress.

U.S. Pat. No. 5,874,096 is a continuation of U.S. Pat. No. 5,550,224. Major difference is reduction of use rates to a range of 1.4 to 17 oz per 100 gallons spray mix of modified and natural guar.

U.S. Pat. No. 5,824,797 discloses a method for improving deposition characteristics by using guar to increase in placement of spray onto target which increases bioefficacy and efficiency of the spray.

U.S. Pat. No. 5,525,575 relates to systemic activity of pesticide systems which can be enhanced by incorporating water soluble polymers such as nonionic polymer acrylamides of sufficiently low molecular weight as to have little or no effect on the diluted herbicide spray pattern. The composition may exist as a reverse phase emulsion or dispersion, water soluble solution, or powder. Compatibility of nonionic polymer in the spray mixture is not an issue.

U.S. Pat. No. 5,529,975 shows that systemic activity of pesticide systems can be enhanced by incorporating water soluble polymers such as nonionic polymer acrylamides of a high molecular weight so as not to effect the spray pattern of the diluted herbicide spray. The composition exists as a reverse phase emulsion or dispersion. And because the polymers are nonionic, compatibility in the spray mixture is not a problem. However, nonionic polymers historically are not stable in highly electrolyte solutions such as a concentrated glyphosate solution or a concentrated fertilizer solution such as ammonium sulfate.

U.S. Pat. No. 4,510,081 shows use of dual polymer system to develop a drift control concentrate. Polymer 1 mentioned is derived from a group of polysaccharides such as xanthan, guar, starch, cellulose gums, and the like, is a water thickener and is not viscoelastic. Polymer 2 forms a viscoelastic solution in water and is derived from several chemical groups including polyacrylamide (nonionic and anionic) polymers. Use rates of formulated product range from Ito 30 oz per 100 gallons spray and function as an anti-drift agent. Examples cited are oil based formulations (liquid concentrates).

### SUMMARY OF THE INVENTION

The invention involves both a process and a composition for producing ionically balanced acrylamide polymer-containing compositions with enhanced performance properties.

As mentioned above, the present invention relates to improving the compatibility of highly cationic pesticide/herbicide formulations in sprayable aqueous systems for application to plants, crops, fields and the like and for that purpose provides ionically balanced acrylamide polymer-containing compositions that exhibit enhanced performance properties when formulated with highly cationic pesticide systems. The compositions of this invention are sufficiently ionically balanced to insure compatibility with highly cationic pesticide formulations. Thus, the compositions of the invention include an ionically balanced composition comprising an admixture of at least one anionic acrylamide polymer and optionally, a nonionic polymer and an ionically counterbalancing agent. A source of nitrogen, such as an ammonium salt can function as the ionically counterbalancing agent added to balance the ionic properties of the composition containing the highly cationic pesticide system. Other ingredients to balance the ionic charges of the polymer could also be used in place of the nitrogen source or in addition thereto.

Examples of compounds that can be used as an ionically counter balanced agent are water soluble compounds such as inorganic nitrogen containing salts, e.g., ammonium sulfate, ammonium nitrate, urea, ammonium bisulfate, ammonium citrate, ammonium phosphate and the like.

More particularly, the compositions of the invention include a) an adjuvant composition, b) a concentrate composition containing the adjuvant of (a) and a cationic pesticide formulation and c) a spray tank mixture comprising the adjuvant, cationic pesticide formulation and ionically balancing agent.

The spray tank mixture also contains water so that a solution or dispersion can be readily sprayed onto the plant, crop, field or soil.

As used herein, the term “pesticide” is intended to include herbicides.

According to the invention, a water soluble liquid may be produced by adding an ionically counter balanced agent such as mentioned above and other components (defoamers, sequestering agents, surfactants, potentiating agents, humectants, other deposition or anti-drift agents) into a mixing tank. An acrylamide polymer compound is then dissolved into the ionically counter balanced agent solution using a mechanical device such as recirculation pump, powder inductor, cowls type dispersator, modified sand mill or other attrition devices. The resultant mixture is then aged under constant low shear high torque agitation until the polymer is fully hydrated and free of lumps or gel droplets.

The adjuvant compositions according to the present invention include the following:

a) An acrylamide polymer which contains one or more acrylamide polymers of various ionic charges and molecular weights, such that at least one of the acrylamide components is anionic. Acrylamide components may vary from having zero charge and be nonionic in nature to being primarily anionic salts of polyacrylates having charge densities up to 96%. The value to measure the charge is by the ratio of monomer (e.g. an acrylate) to acrylamide % by weight. Molecular weights may range from 50,000 to 25,000,000 or greater. The term “acrylamide” as used herein is intended to mean acrylamide polymers encompassing copolymers of acrylamide with other ethylenically unsaturated comonomers, such as acrylates. Nonionic acrylamide refers to a homopolymer of acrylamide with no ionic character. Anionic acrylamide polymers refers to a co-polymer of acrylamide with, for example, an alkali metal or ammonium salt of acrylic acid. At least one anionic acrylamide component is present in the compositions of this invention. In the preferred embodiment of the invention, a blend of anionic and nonionic acrylamide polymers is employed.

b) An ionically counter balanced agent containing appropriate ionic and/or nonionic components which balance the action of the blend in a) above to be compatible with desired companion tank mix ingredients. Ammonium salts, anionic surfactants, organic acids, and other components have been found useful to ionically counter balance the polymer blend.

c) Alternately, other compatible functionalities which contribute their expected function to the system may be added as well.

### DETAILED DESCRIPTION OF INVENTION

The use of nitrogen sources such as ammonium sulfate to enhance pesticide, particularly herbicide, performance is well documented. The need for deposition enhancement and resistance to drift is also well documented. The need to enhance potentiation of systemic pesticides is well documented. Other desirable components that can be included in the adjuvant compositions of this invention include but are not limited to defoaming agents, surface active agents, potentiating agents, dispersing agents, crystalline inhibitor agents, dry deposition/anti-drift agents, sequestering agents, shear resistant anti-drift agents, and the like.

Anti-drift/deposition enhancement components such as polymer acrylamides, guar, xanthan gums, and other deposition aids are used primarily in a spray mix with pesticides, and most preferably herbicides. It is necessary for those anti-drift/deposition formulations to be compatible with a variety of formulation types. Examples of those formulation types are liquid suspension concentrates, dispersible granules and powders, emulsifiable concentrates, and water solutions of organic or inorganic salts. The included surfactant systems in those formulations may consist of anionic, nonionic, and/or cationic surfactants and other components. These pesticide formulations containing surfactant systems may interact in a negative way with anti-drift formulations. This may result in the polymers not hydrating properly or forming agglomerates which do not disperse properly causing failure of the anti-drift function as well as potentially clogging spray nozzles and screens. Further, there is the potential to interfere with the surfactant activity resulting in reduced efficacy of the pesticide formulation. For example, some new glyphosate formulations exhibit this negative interaction because they are much more highly cationic character than previously commercialized formulations.

Traditional acrylamide polymer formulations show variation of incompatibility with these new products ranging from inability to spray the tank contents due to clogged nozzles and screens to questionable field performance of the anti-drift function as well as efficacy of the herbicide.

While some anti-drift/deposition enhancement formulations have only that single function, most recent products delivered as a part of a multifunctional formulation include other functionalities such as sequestering, defoaming, potentiation enhancement, surface activeness, humectancy, anti crystallization, and others.

It would be a significant advancement to develop and deliver an anti-drift/deposition enhancement composition containing the above desired characteristics and be compatible with a broad range of ionically charged pesticide systems, particularly highly cationic herbicide formulations.

It has been unexpectedly discovered that by modifying the anionic polyacrylamide, reducing the charge to significantly less than 20% anionic character, and by balancing that anionic charge with a properly chosen ionically counterbalancing agent, the resulting adjuvant solution will mix in the spray tank with highly cationic pesticide formulations, such as Round Up Weather Max and Original Max. Typically, the anionic polyacrylamide would have a charge of 1 to 19%, preferably 2 to 10%. Dependent on the anionic charge, the amount of balancing agent is determined. For example, a 29% anionic charges may need 20T balancing agent and a 5% anionic charge may need 7% balancing agent. The spray solution can be applied to crops or soil through the spray tips without forming gels or insolubles which would otherwise stop up screens, nozzles, and spray tips. The enhanced deposition and anti drift properties of the base polyacrylamide component in the spray solution is surprisingly still effective despite being stored and sprayed in a high electrolyte solution.

U.S. Pat. Nos. 5,525,575 and 5,529,975 teach the value of nonionic polyacrylamides with sufficiently low molecular weights such as to not effect the spray pattern and their ability to enhance systemic activity of pesticides. It has been unexpectedly discovered that by using anionic polyacrylamides that have been modified by reducing the charge to significantly less than 20% anionic character, by raising the molecular weight of the polymer to have a positive effect on deposition and anti-drift properties, and by balancing that anionic charge with a properly chosen ionically counter balancing agent, the resulting adjuvant solution will enhance systemic activity of pesticides such as a herbicide like glyphosate.

U.S. Pat. No. 6,288,010 teaches that anionic polyacrylamides having an anionic charge of 20% or greater have solubility in high electrolyte solutions such as 10% to 34% ammonium sulfate and such as concentrated glyphosate solutions. It has been unexpectedly discovered that an anionic polyacrylamide polymer of anionic charge much less than 20% can be blended into an ionically balanced nitrogen based solution, such as an ammonium sulfate solution of 5 to 20% AMS or such as a pesticide concentrate like glyphosate, to form single-phase stable solutions. This wide electrolyte tolerance can be achieved with at least one anionic polymer and optionally, a nonionic polymer and blends of nonionic/ionic acrylamide polymers and a nitrogen based ionic balancing agents such as ammonium salts of nitrates, sulfates, phosphates as well as urea. The ammonium salts include, but are not limited to ammonium sulfate, ammonium chloride, ammonium metaphosphate, ammonium nitrate, diammonium phosphate, monoammonium phosphate, ammonium phosphate nitrate, ammonium phosphate sulfate, ammonium polysulfate, ammonium polyphosphate, ammonium sulfate nitrate, ammonium thiosulfate, ammonium polysulfide, ammonium citrate and urea and mixtures thereof.

The adjuvant concentrate products of this invention include liquid concentrates containing the anionic acrylamide polymers, and which may also include one or more other ingredients such as a nitrogen source, defoamer, sequestering agent, surfactant and the like. The adjuvant concentrate would then be diluted into a fertilizer solution by mixing 10%-30% of the concentrate into the fertilizer, preferably an ammonium sulfate, solution to make a ready-to-use adjuvant, which is soluble. This fertilizer and acrylamide polymer mixture is subsequently tank mixed with highly cationic pesticide formulation such as a herbicide like glyphosate and sprayed onto growing plants or soil without forming gels and other undesirable entities which could cause clogging of nozzles, screens, and spray tips. Thus, the invention avoids problems at the application point which would reduce the efficiency of the pesticide.

Another form of the adjuvant product of this invention is as a liquid ready-to-use formulation which is tank mixed with a pesticide such as a herbicide like glyphosate and sprayed onto growing plants or soil without forming gels and other undesirable entities which could cause clogging of nozzles, screens, and spray tips. In this way, problems at the application point resulting in reducing the efficiency of the pesticide can be avoided.

Another form of the adjuvant product of this invention is as a liquid polymer concentrate, which is added to a pesticide concentrate, such as a herbicide like glyphosate, to produce a stable solution. This pesticide concentrate can be packaged for sale and added to the spray tank producing a sprayable solution, which will not cause clogging of nozzles, screens, and spray tips. In this way, also problems at the application point resulting in reducing the efficiency of the pesticide can be avoided.

Ready-to-use emulsions or dispersions in the form of concentrate are also contemplated.

The compositions of the present invention can preferably contain a mixture of non-ionic and anionic acrylamide polymers. Typical formulation could contain up to 20% anionic polymer character with the balance being non-ionic.

The key to determining if the compositions of this invention are ionically balanced is observing the solubility characteristics of the compositions. That is, when properly formulated, the compositions of the invention are gel-free and free of particulates.

It has been observed as noted above that compatibility problems arise when acrylamide polymers are blended with highly cationic pesticide formulations. Frequently, gelling occurs or undissolved particulates remain which clog spray equipment.

Therefore, to determine the compatibility of the selected acrylamide polymer with the selected pesticide, theses two components are blended together and then the selected ionically balancing agent is added thereto until a gel-free, particulate free liquid sprayable composition is obtained. A record or tabulation is then prepared identifying selected specific acrylamide polymers and selected specific pesticides which are compatible with each other in the presence of specific ionically balancing agents to produce a gel-free, particulate free composition. Then the adjuvant concentrate compositions can be prepared from the selected specific acrylamide polymers and the specific selected ionically balancing agent. The adjuvant concentrate is then ready for use with the specific selected pesticide whose compatibility was previously determined and identified in the record or tabulation.

To prepare the adjuvant-pesticide concentrate, the adjuvant concentrate is mixed with the pesticide as identified in the record or tabulation as being compatible into the adjuvant.

When the adjuvant-pesticide concentrate formulated as above is then diluted for the spray tank, it will enable the formation of a gel-free, particulate free sprayable liquid.

### EXAMPLE 1

1. Manufacturing Procedure

| A. Formula | |
|---|---|
| Raw Material | % |
| Water | 95.10 |
| AU-314 defoamer | 0.55 |
| (Dimethyl siloxane emulsion) | |
| Agnique 2069 (Cognis) | 3.00 |
| (alkyl polyglycoside surfactant) APG | |
| Proxel GXL | 0.05 |
| (preservative) | |
| Magnafloc 351 (Ciba Specialty) | 1.30 |
| (Anionic/Nonionic polyacrylamide) | |
| Total | 100.0 |

B. Raw Materials Receiving Procedure

Upon arrival of raw material, pull an 8 ounce sample for analysis. Perform mandatory Quality Control Tests for unloading. Permit unloading of Raw Material. Perform additional tests as required by Raw Material Specifications.

C. Plant Processing

1. In the main mixing vessel add in above order all of ingredients except the Magnafloc 351. Continue agitation and recirculation for 30 minutes minimum after last addition to main vessel. Addition of sodium hydroxide to the top of the tank creates a reaction that is exothermic and solution will heat up slightly. Add increments to bring pH of main vessel into final pH limits. pH cannot be adjusted after polymer is added) Add the Magnafloc 351 via eductor until all is added. Age the mix overnight in aging tank with air sparge. Pull sample for analysis. The resulting solution is clear and free of gel and particulates.

### EXAMPLE 2

1. Manufacturing Procedure

| A. Formula | |
|---|---|
| Raw Material | % |
| Water | 32.50 |
| Ammonium sulfate 40% solution | 40.00 |
| Phosphoric Acid 85% | 4.00 |
| Citric Acid solution 50% | 4.00 |
| Sodium Hydroxide 50% | 4.10 |
| Glycerin 99.5% (Cognis) | 10.75 |
| AU-314 defoamer | 0.50 |
| Agnique 2069-APG (Cognis) | 3.00 |
| Proxel GXL preservative | 0.05 |
| Magnafloc 351 (Ciba) | 1.10 |
| Anionic Nonionic polyacrylamide | |
| Totals | 100.00 |

B. Raw Materials Receiving Procedure

Upon arrival of raw material, pull an 8-ounce sample for analysis. Perform mandatory Quality Control Tests for unloading. Permit unloading of Raw Material. Perform additional tests as required by AUI Raw Material Specifications.

C. Plant Processing

1. In the main mixing vessel add in above order all of ingredients except the Magnafloc 351. Continue agitation and recirculation for 30 minutes minimum after last addition to main vessel. Addition of sodium hydroxide to the top of the tank creates a reaction that is exothermic and solution will heat up slightly. Add increments to bring pH of main vessel into final pH limits. pH cannot be adjusted after polymer is added). Add the Magnafloc 351 via eductor until all is added. Age overnight in aging tank with agitation. Pull sample for analysis. The resulting solution is clear and free of gel and particulates.

### EXAMPLE 3

1. Manufacturing Procedure

| A. Formula | Std |
|---|---|
| Raw Material | % |
| Water | 50.6 |
| Glycerin 99.5%-Emery 916 (Cognis) | 10.00 |
| Ammonium sulfate 40% solution | 25.00 |
| 32% nitrogen solution | 3.00 |
| Phosphoric Acid 85% | 2.00 |
| Citric Acid solution 50% | 2.00 |
| Sodium Hydroxide 50% (Caustic soda liq) | 2.80 |
| AU-314 defoamer | 0.40 |
| Agnique 2069 APG (Cognis) | 2.00 |
| Agnique 2067 APG (Cognis) | 1.00 |
| Proxel GXL Preservative | 0.05 |
| Magnafloc 156 or 156 F (Ciba Specialty) | 1.10 |
| Anionic/Nonionic polyacrylamide | |
| Totals | 100 |

APG = alkyl polyglycoside surfactant

B. Raw Materials Receiving Procedure

Upon arrival of raw material, pull an 8-ounce sample for analysis. Perform mandatory Quality Control Tests for unloading. Permit unloading of Raw Material. Perform additional tests as required by Raw Material Specifications.

C. Plant Processing

1. In the main mixing vessel add ingredients, in the above order, through the caustic soda. Add the caustic soda cautiously to the top of the tank and pull sample for pH analysis. Note that reaction is exothermic and solution will heat up slightly. Check pH of the solution and adjust as necessary to a pH of 5.0 to 6.5. pH cannot be adjusted after polymer is added to the mix. Add additional ingredients except the Magnafloc 156. Educt the quantity of Magnafloc 156 with the final solution into the curing tank. Continue agitation overnight or until solution is free from undissolved polymer. Note that 156F will hydrate quicker than 156 due to its small particle size. Pull sample every 30 minutes to check for completion of hydration. Release for shipment if all parameters meet specifications. Pump through filter containing a new 400 micron screen and filter carefully onto truck which is properly cleaned. The final product is a clear solution free of gel and particulates.

### EXAMPLE 4

1. Manufacturing Procedure

| A. Formula | Std |
|---|---|
| Raw Material | % |
| Water | 50.65 |
| Glycerin 99.5%-Emery 916 (Cognis) | 2.00 |
| Ammonium sulfate 40% solution | 85.00 |
| Phosphoric Acid 85% | 0.40 |
| Citric Acid solution 50% | 0.40 |
| Sodium Hydroxide 50% (Caustic soda liq) | 0.56 |
| AU-314 defoamer | 0.08 |
| Agnique 2069 (Cognis) | 0.40 |
| (alkyl polyglycoside surfactant) | |
| Agnique 2067 (Cognis) | 0.20 |
| (alkyl polyglycoside surfactant) | |
| Proxel GXL Preservative | 0.01 |
| Magnafloc 156 or 156 F (Ciba Specialty) | 0.22 |
| (Anionic/Nonionic polyacrylamide) | |
| Totals | 100 |

B. Raw Materials Receiving Procedure

Upon arrival of raw material, pull an 8-ounce sample for analysis. Perform mandatory Quality Control Tests for unloading. Permit unloading of Raw Material. Perform additional tests as required by Raw Material Specifications.

C. Plant Processing

1. In the main mixing vessel add ingredients, in the above order, through the caustic soda. Add the caustic soda cautiously to the top of the tank and pull sample for pH analysis. Note that reaction is exothermic and solution will heat up slightly. Check pH of the solution and adjust as necessary to a pH of 5.0 to 6.5. pH cannot be adjusted after polymer is added to the mix.). Add additional ingredients except the Magnafloc 156. Educt the quantity of Magnafloc 156 with the final solution into the curing tank. Continue agitation overnight or until solution is free from undissolved polymer. Note that 156F will hydrate quicker than 156 due to its small particle size. Pull sample every 30 minutes to check for completion of hydration. Release for shipment if all parameters meet specifications. Pump through filter containing a new 400 micron screen and filter carefully onto truck which is properly cleaned. The final product is a clear solution free of gel and particulates.

### EXAMPLE 5

Polymer concentrate

| Formula | |
|---|---|
| Raw Material | % |
| Water | 48.1 |
| Glycerin | 35.0 |
| AU-314 deformer | 0.7 |
| Citric Acid 50% | 1.0 |
| Tallowamine POE 20 | 15.0 |
| Magnafloc 351 polymer | 0.7 |
| Total | 100 |

Manufacturing Procedure

Add all ingredients except 351 polymer. Adjust PH to 6.0 to 6.5 with additional citric acid if necessary. Educt the polymer into the solution and bled. Transfer blend into aging tank and age under low torque agitation overnight.

Pesticide concentrate

| Formula | |
|---|---|
| Raw Material | % |
| Glycerin IPA salt 62% | 66.1 |
| Water | 18.9 |
| Polymer concentrate | 15.0 |
| Total | 100 |

Further variations and modifications of the above will be apparent to those skilled in the art from the foregoing and are intended to be encompassed by the claims appended hereto.

1. An ionically balanced composition for applying to soil or plants comprising an aqueous solution of at least one anionic acrylamide polymer and optionally, a nonionic polymer, and a sufficient amount of an ionically counterbalancing agent to form a clear solution free of particulates.

2. The composition according to claim 1, where the ionically counterbalance agent is a nitrogen source.

3. The composition according to claim 2, wherein the nitrogen containing source is an ammonium salt.

4. The composition according to claim 3, wherein the ammonium salt is a member selected from the group consisting of ammonium sulfate, ammonium chloride, ammonium metaphosphate, ammonium nitrate, diammonium phosphate, monoammonium phosphate, ammonium phosphate nitrate, ammonium phosphate sulfate, ammonium polysulfate, ammonium polyphosphate, ammonium sulfate nitrate, ammonium thiosulfate, ammonium polysulfide, ammonium citrate and urea and mixtures thereof.

5. The composition according to claim 1, wherein the nitrogen containing source is ammonium sulfate.

6. The composition according to claim 1, wherein the polymer of acrylamide is a copolymer with up to 20% by weight of an unsaturated comonomer.

7. The composition according to claim 6, wherein the polymer is a copolymer of acrylamide and an acrylate monomer.

8. The composition according to claim 7, wherein the acrylate monomer is an alkali metal or ammonium salt of acrylic acid.

9. The composition according to claim 1, wherein the anionic acrylamide polymer has less than 20% anionic character.

10. An aqueous adjuvant concentrate comprising an aqueous solution of a water soluble anionic acrylamide polymer, optionally a nonionic polyacrylamide and an ionically counterbalancing diluent which concentrate is free of gels and particulates.

11. The concentrate according to claim 9, in which the solution additionally contains an active ingredient which is a pesticide.

12. The concentrate according to claim 10, wherein the herbicide is glyphosate amine salt, or potassium salt thereof or other water soluble form, or a phenoxy herbicide as an amine or metallic salt or in its free acid form.

13. The concentrate according to claim 11, in which the acrylamide polymer is formed from 80 to 95% acrylamide and up to 20% ethylenically unsaturated anionic monomer.

14. The concentrate according to claim 10, in which the acrylamide polymer is a blend of a nonionic polyacrylamide and anionic acrylamide polymer.

15. The concentrate according to claim 10, which additionally contains a nitrogen containing source, and optionally a surfactant.

16. The concentrate according to claim 10, wherein the anionic acrylamide polymer has less than 20% anionic character.

17. A sprayable tank mixture comprising an aqueous solution of an anionic acrylamide polymer, a cationic pesticide formulation and an ionically balancing agent in sufficient amount form an aqueous solution free of gels and particulates.

18. The sprayable tank mixture of claim 15 wherein a non-ionic acrylamide polymer is also present.

19. The sprayable tank mixture of claim 15, wherein the pesticide is an glyphosate herbicide.

20. The sprayable tank mixture of claim 15, wherein the ionically balancing agent is a source of nitrogen.

21. The sprayable tank mixture of claim 18, wherein the source of nitrogen is an ammonium salt.

22. The sprayable tank mixture of claim 19, wherein the ammonium salt is a member selected from the group consisting of ammonium sulfate, ammonium chloride, ammonium metaphosphate, ammonium nitrate, diammonium phosphate, monoammonium phosphate, ammonium phosphate nitrate, ammonium phosphate sulfate, ammonium polysulfate, ammonium polyphosphate, ammonium sulfate nitrate, ammonium thiosulfate, ammonium polysulfide, ammonium citrate and urea and mixtures thereof.

23. The sprayable tank mixture according to claim 17, wherein the anionic acrylamide polymer has less than 20% anionic character.

24. A method of making an aqueous concentrate comprising mixing together at least one acrylamide polymer, water and an ionically counterbalanced diluent to form a solution free of gels and particulates.

25. The method according to claim 21, which additionally comprises adding a nitrogen containing source to the concentrate, and optionally at least one of a surfactant and a pesticide.

26. A method of making an ionically balanced composition suitable for application to soil or a plant comprising forming an admixture of at least one anionic acrylamide polymer, cationic pesticide formulation, and an ionically counterbalancing agent and optionally, a surfactant determining if said admixture forms a sprayable solution free of gels and particulates, preparing a record or tabulation of said admixture so as to enable a match-up of acrylamide polymer, cationic pesticide formulation and ionically counterbalancing agent.

27. The method according to claim 23, where the ionically counterbalanced diluent is a nitrogen source in the composition to be applied to the soil or plant.

28. The method according to claim 24, wherein the nitrogen containing source is an ammonium salt.

29. The method according to claim 25, wherein the ammonium salt is ammonium sulfate.

30. The method according to claim 23, wherein the composition contains a mixture of a nonionic acrylamide polymer and an anionic acrylamide polymer.

31. The method according to claim 24, wherein the anionic acrylamide polymer has less than 20% anionic character.
